(19) United States
(12) Patent Application Publication
(10) Pub. No.: US 2024/0236754 A9
(43) Pub. Date: Jul. 11, 2024

(54) SENSOR WITH A DYNAMIC DATA RANGE

(71) Applicant: Robert Bosch GmbH, Stuttgart (DE)

(72) Inventors: Dorde Cvejanovic, Muenchen (DE); Jan Hayek, Muenchen (DE)

(21) Appl. No.: 18/454,902

(22) Filed: Aug. 24, 2023

(30) Foreign Application Priority Data
Oct. 21, 2022 (DE) 10 2022 211 197.4

(51) Int. Cl. H04W 28/02; H04W 28/08

(52) U.S. Cl. CPC H04W 28/0226; H04W 28/0967

(57) ABSTRACT

A sensor with a dynamic data range. The sensor generates sensor values at consecutive time points. The sensor is configured in such a way that the data range is subjected, after each time point, to a treatment corresponding to one of the following treatment options performed as a function of the generated sensor values, wherein the treatment options include:—increasing the data range if n of the generated sensor values are outside the data range during a first time window,—decreasing the data range if m of the generated sensor values are within the data range during a second time window, and—otherwise leaving the data range unchanged. A method for automatically adjusting a data range of such a sensor is also described.

### CROSS REFERENCE

The present application claims the benefit under 35 U.S.C. § 119 of German Patent Application No. DE 10 2022 211 197.4 filed on Oct. 21, 2022, which is expressly incorporated herein by reference in its entirety.

### FIELD

The present invention relates to a sensor. The present invention furthermore relates to a method for adjusting a data range of a sensor.

### BACKGROUND INFORMATION

A wide range of different sensors exists for a wide variety of application areas. For example, there are speed, pressure, temperature, or inertial sensors which can be used, for example, in consumer electronics, in the automotive industry, or also in industrial applications. In particular, MEMS (micro-electro-mechanical systems) sensors are increasingly used, which may be designed as acceleration or rotation rate sensors, for example.

Depending on the application, the physical quantity to be detected and the expected sensor values, the data range to be sensed by a sensor is usually selected or set by the user. Taking all circumstances into account, the user decides to compromise between the size of the data range and the resolution of the sensor. A larger data range is accompanied by a coarser and thus worse resolution. An improved, i.e., more precise, resolution can be achieved simply but at the price of a smaller data range. Consequently, the user-induced specification of the data range presents a challenge in the setting of sensors. In addition, such sensors require that the provided sensor values have to be interpreted differently depending on the sensor setting, which requires a higher (computational) effort and, in some circumstances, may require additional or more complex software and hardware. Such a sensor is described, for example, in German Patent Application No. DE 10 2018 214 600 A1, in particular in paragraphs [0006], and [0008]. In this respect, the task is to provide a sensor that does not have the aforementioned disadvantages of the related art.

### SUMMARY

This task may be achieved by a sensor with a dynamic data range according to the present invention. According to an example embodiment of the present invention, the sensor generates sensor values at consecutive time points, and the sensor is configured in such a way that the data range is subjected, after each time point, to a treatment corresponding to one of the following treatment options performed as a function of the generated sensor values, wherein the treatment options include
increasing the data range if n of the generated sensor values are outside the data range during a first time window,
decreasing the data range if m of the generated sensor values are within the data range during a second time window, and
otherwise leaving the data range unchanged.

The sensor according to an example embodiment of the present invention can generate sensor values at discrete consecutive time points. Preferably, the consecutive time points are immediately consecutive. In other words, a sensor value is preferably generated at any time point that can be measured by the sensor. It is also possible that the consecutive time points are not immediately consecutive. Consequently, the sensor may also generate a sensor value at every second, third, fourth, etc. measurable time point. The generation of sensor values at not immediately consecutive time points has the advantage that the sensor can be operated with a low energy input.

Furthermore, the sensor according to an example embodiment of the present invention has a data range that is subjected to a treatment option after each time point. As a function of the sensor values generated, the data range is subjected to one of three possible treatment options listed below.

The data range can be increased if a number n, e.g., three, of the generated sensor values are outside the data range during a first time window, for example of 100 ms. Sensor values are outside the data range if they are not in an interval bounded by the largest value of the data range and the smallest value of the data range.

The data range can also be decreased if a number m, e.g., six, of the generated sensor values are within the data range during a second time window, for example of four seconds. Alternatively, the sensor may be configured in such a way that the data range is decreased if a number k of the generated sensor values is not outside the data range during the second time window. The number n of the generated sensor values during the first time window may be greater than, less than, or equal to the number m or k of the generated sensor values during the second time window. Moreover, the first time window may be less than or greater than or equal to the second time window. Furthermore, the first and/or the second time window can be replaced by a number of measured sensor values in each case. In other words, the first and second time windows may in each case be specified in the unit of seconds or may also be unitless. The numbers n, m and k may be predetermined and constant during sensor operation or may be ascertained and set by a program, algorithm or method in real-time, e.g., by a control device. In addition, the sensor may be configured in such a way that the data range is adjusted after or before a current time window ends. For both an increase and a decrease of the data range, the sensor may additionally comprise an electronic unit, e.g., a counter, which captures in real time which or how many of the generated sensor values are outside and which or how many are within the data range, for example by increasing a counter value.

The data range may also be left unchanged. In particular, after initial activation and use of the sensor and the first generated sensor values, no adjustment to the data range may be required since a time window could not have ended yet. In this respect, leaving the data range unchanged constitutes a special case in that it does not involve any change to the data range.

Overall, a sensor according to the present invention may have an advantage that the data range is time-variable, i.e., dynamic. The need for manual or user-induced initial input of the data range and for active switching of the data range during sensor operation can be eliminated since the data range adjusts autonomously, i.e., automatically, to the detected sensor values. Furthermore, the sensor control can be simplified.

In a first example embodiment of the present invention, the data range comprises at least one dynamically variable bound, wherein the dynamically variable bound is an upper bound of the data range and/or a lower bound of the data range. In order to change the data range, only the upper bound or the lower bound needs to be changed. The data range may also be changed by changing the upper bound and simultaneously changing the lower bound. The data range may be symmetric, for example with respect to a zero value of a scale. The data range may have both a positive and a negative subrange. The positive subrange and the negative subrange may be of the same in size. Alternatively, the data range may be asymmetric, for example with respect to a zero point, i.e., the positive subrange and the negative subrange may differ in size. The data range may also comprise only positive or only negative values.

In a further example embodiment of the present invention, it is provided that only the upper bound of the data range is variable and the lower bound has a constant value. The lower bound, which is less than the upper bound, may have a constant positive or constant negative value. The lower bound may also have the fixed value zero, with adjustments to the data range being realized only via the upper bound thereof. Both an increase and a decrease of the data range can consequently be carried out by changing the upper bound.

An alternative example embodiment of the present invention provides that only the lower bound of the data range is variable and the upper bound has a constant value.

A further example embodiment of the present invention provides that the data range can be increased by 50%-200%, preferably by 100%. The data range can be increased to different extents via the upper and lower bounds. For example, a desired increase of the data range, e.g., by 100%, can be carried out at two thirds via an increase of the upper bound and at one third by a decrease of the lower bound, wherein the extents can be selected as desired. It can be stored in a control that the extent of the increase in the data range is the same every time the data range is changed, i.e., that the data range is successively increased to the same extent. The extent of increase may also be variable, i.e., different in two consecutive increase steps. The extent of the increase may be linked to one or more conditions. The data range can be increased as desired by multiple changes.

In a preferred example embodiment of the present invention, it is provided that the sensor is configured in such a way that the data range is increased only by changing the upper bound of the data range. In one embodiment in which only the upper bound is variable for increasing the data range, the sensor can be equipped with a simplified control.

A preferred example embodiment of the present invention provides that the data range can be decreased by 20%-60%, preferably by 50%. The data range can be decreased to different extents via the upper and lower bounds. For example, a desired decrease of the data range, e.g., by 50%, can be carried out at two thirds via a decrease of the upper bound and at one third by a decrease of the lower bound, wherein the extents can be selected as desired. It can be stored in a control that the extent of the decrease in the data range is the same every time the data range is changed, i.e., that the data range is successively decreased to the same extent. The extent of decrease may also be variable, i.e., different in two consecutive decrease steps. The extent of the decrease may be linked to one or more conditions. The data range can be decreased as desired by multiple changes.

In an advantageous example embodiment of the present invention, it is provided that the sensor is configured in such a way that the data range is decreased only at the upper bound of the data range. Decreasing the data range at only the upper bound has the advantage that the control of the sensor can be simplified.

A further subject matter of the present invention is a method for adjusting a data range of a sensor. According to an example embodiment of the present invention, in the method,
sensor values are generated by means of the sensor at consecutive time points,
the data range is subjected, after each time point, to a treatment corresponding to one of the following treatment options performed as a function of the generated sensor values, wherein the treatment options include
   increasing the data range if n of the generated sensor values are outside the data range during a first time window,
   decreasing the data range if m of the generated sensor values are within the data range during a second time window, and
   otherwise leaving the data range unchanged.

The method according to the present invention has the same advantages and technical effects as were explained in connection with the sensor according to the present invention.

### BRIEF DESCRIPTION OF THE DRAWINGS

As discussed above, there are various ways to advantageously design and develop the teaching of the present invention. In this respect, reference is made to disclosure herein including the following description of an exemplary embodiment of the present invention on the basis of the figures.

FIG. 1 schematically shows a data range increase and a data range decrease for a sensor according to an example embodiment of the present invention with a variable upper bound and a constant lower bound.

FIG. 2 shows a schematic program flow for an implementation of a data range increase, according to an example embodiment of the present invention.

FIG. 3 shows a schematic program flow for an implementation of a data range decrease, according to an example embodiment of the present invention.

### DETAILED DESCRIPTION OF EXAMPLE EMBODIMENTS

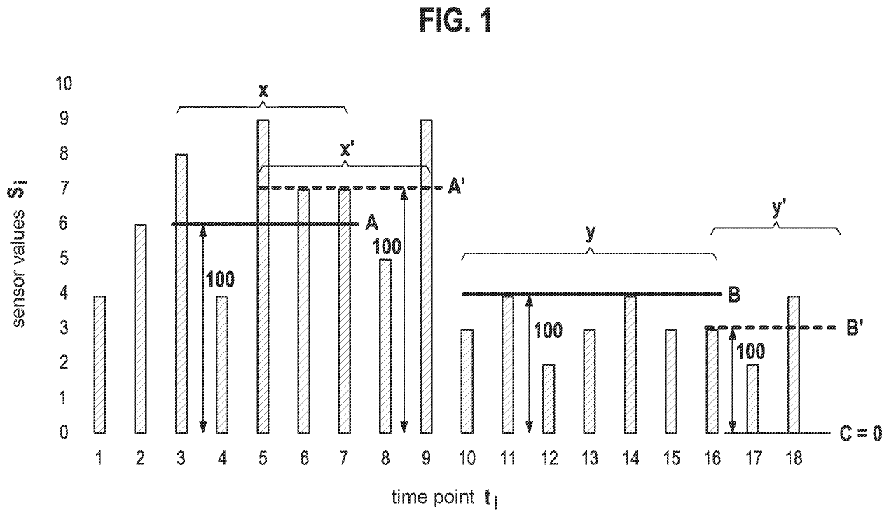

FIG. 1 shows, by way of example, an increase and a decrease of a data range 100 for a sensor according to the invention. On the abscissa, the time is plotted in the form of discrete time points tᵢ. Sensor values Sᵢ which are generated and provided by the sensor are plotted on the ordinate.

The left half of FIG. 1 illustrates a data range increase, which is performed at the time point t₅. In the exemplary embodiment shown, an upper bound A of the data range 100 has the value 6 for a first time window x, wherein the first time window x lasts from t₃ to t₇, i.e., comprises five consecutive time points. The upper bound A may be entered by a user for the first time when the sensor is switched on. The upper bound may alternatively also take on a last saved value when the sensor is switched on or used again. The data range 100 furthermore has a constant lower bound C, the value of which is zero. In other words, the data range 100 of the sensor shown in FIG. 1 can be increased only via the upper bound A.

The sensor whose sensor values Sᵢ are depicted in FIG. 1 is configured in such a way that the upper bound A being exceeded twice (n=2) during the first time window x causes the sensor to increase the data range. The sensor may alternatively be designed in such a way that reaching the upper bound A is equivalent to exceeding it, i.e., that the generated sensor values can reach at least the value of the upper bound, without having to exceed it, in order to bring about a data range increase. The number n can be selected or set freely so that n=1, 3, 4 or 5 is also possible in the exemplary embodiment according to FIG. 1. A control of the sensor is designed in such a way that the logical condition n≤x is ensured, i.e., that the number n, which reflects the maximum permitted number of exceedances of the upper bound A of the sensor values Sᵢ, cannot be greater than the number of time points of the first time window x. By means of such a configuration, the sensor can automatically or autonomously increase its data range.

At the time point t₅, the condition for the data range increase, namely, the second exceedance of the current upper bound A, is satisfied so that the upper bound A is increased. In the present embodiment of the invention, the upper bound A, and thus also the data range 100 due to the constant lower bound C=0, is increased by 16.67% to A′=7. At the time point t₅, a new time window x′ automatically begins, which in the example shown likewise lasts for five consecutive time points.

The right half of FIG. 1 illustrates a data range decrease, which is performed at the time point t₁₆. In the exemplary embodiment shown, an upper bound B of the data range 100 has the value 4 for a second time window y, wherein the first time window y lasts from t₁₀ to t₁₆, i.e., comprises seven consecutive time points. The upper bound B may also be entered by a user when the sensor is switched on for the first time. The upper bound B may alternatively also take on a last saved value when the sensor is switched on or used again. The lower bound C is unchangedly constant and consequently has the value zero.

Undershooting the upper bound B five times (m=5) during the second time window y causes the sensor to decrease the data range, wherein the number m can be selected or set freely so that m=1, 2, 3, 4, 6 or 7 is also possible in the exemplary embodiment according to FIG. 1. At the last time point t₁₆ of the second time window y, the condition for the data range decrease, namely, the fifth undershooting of the current upper bound B, is satisfied so that the upper bound B is decreased. In the present embodiment of the invention, the upper bound B, and thus also the data range 100 due to the constant lower bound C=0, is decreased by 20% to B′=3.2. At the time point t₁₆, a new time window y′ automatically begins.

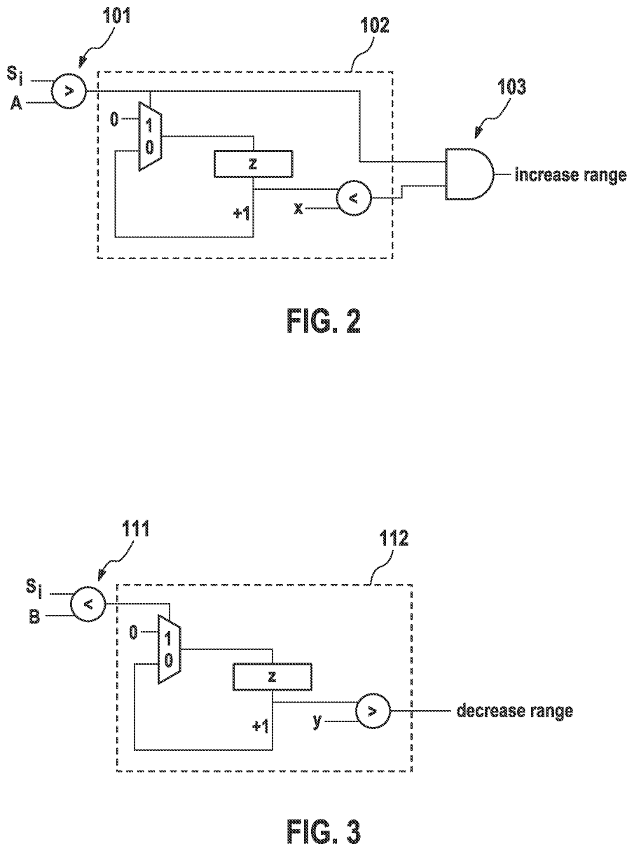

FIG. 2 schematically shows an implementation of a data range increase. At the beginning, in a process step 101, a comparison between the currently generated sensor value Sᵢ and the current upper bound A of the data range 100 is carried out. If the sensor value Sᵢ is greater than the upper bound A, the process step 102 is initiated. In the course of the process step 102, a counter variable z is increased by the value one. The counter variable z captures how many sensor values Sᵢ of the current time window x are outside the data range 100 or greater than the upper bound A. Subsequently, it is checked whether the value of the counter variable z has reached the number n required for a data range increase, wherein the number n reflects the number of exceedances of the upper bound A at which a data range increase is performed. Specifically, it is checked whether z is greater than or equal to n, wherein checking for equality would be sufficient. If z is greater than or equal to n, a data range increase is performed in a process step 103, wherein an extent of the data range increase is saved in advance in the sensor. After each data range increase, the counter variable z is set to the value zero and a new time window x′ begins. In addition, a control variable i, whose value is increased by one when the value of the counter variable z is increased by the value one, is reset to the value one in order to be able to capture in the new time window x′ at which current time point tᵢ, the sensor or the sensor values Sᵢ are. In other words, a new time window x′ begins every time a data range increase is performed or the time window x is ended.

If the counter variable z is incremented, but the number n required for a data range increase is not reached, i.e., z is still less than n, a next sensor value Sᵢ₊₁ can be generated and compared to the upper bound A if the current time window x is not ended at the same time. The check whether a current time window x is still running is carried out with the control variable i, wherein it is checked whether the value of the control variable i is greater than the time window x.

If the current sensor value Sᵢ is less than or equal to the value of the current upper bound A of the data range 100, the generated sensor value Sᵢ is not outside the data range 100. Consequently, the counter variable z is not incremented.

FIG. 3 schematically shows an implementation of a data range decrease. A data range decrease is carried out taking into consideration the logical operators analogously to the data range increase described in the context of FIG. 1 and FIG. 2. In a process step 111, it is checked whether the currently generated sensor value Sᵢ is less than the value of the current upper bound B of the data range 100. If Sᵢ is less than B, the counter variable z is increased by the value one in a subsequent process step 112. If m of the generated sensor values Sᵢ are within the data range 100, the data range 100 is decreased by decreasing the upper bound B to the value B′.

### LIST OF REFERENCE SIGNS

100 Data range
Sᵢ Sensor values
tᵢ Time points
A Upper bound before data range increase
A′ Upper bound after data range increase
B Upper bound before data range decrease
B′ Upper bound after data range decrease
C Lower bound
x First time window
y Second time window
x′ New time window after a data range increase
y′ New time window after a data range decrease
z Counter variable
i Control variable

What is claimed is:

1. A sensor with a dynamic data range, wherein the sensor is configured to generate sensor values at consecutive time points, and is configured in such a way that the data range is subjected, after each time point, to a treatment corresponding to one of the following treatment options performed as a function of the generated sensor values, wherein the treatment options include:
increasing the data range if n of the generated sensor values are outside the data range during a first time window,
decreasing the data range if m of the generated sensor values are within the data range during a second time window, and
otherwise leaving the data range unchanged.

2. The sensor according to claim 1, wherein the data range has at least one dynamically variable bound, wherein the dynamically variable bound is an upper bound of the data range and/or a lower bound of the data range.

3. The sensor according to claim 2, wherein only the upper bound of the data range is variable and the lower bound has a constant value.

4. The sensor according to claim 2, wherein only the lower bound of the data range is variable and the upper bound has a constant value.

5. The sensor according to claim 1, wherein the data range can be increased by 1%-20%.

6. The sensor according to claim 2, wherein the sensor is configured in such a way that the data range is increased only by changing the upper bound of the data range.

7. The sensor according to claim 1, wherein the data range can be decreased by 1%-20%.

8. The sensor according to claim 2, wherein the sensor is configured in such a way that the data range is decreased only at the upper bound of the data range.

9. A method for adjusting a data range of a sensor, the method comprising:
generating sensor values at consecutive time points, using the sensor; and
subjecting the data range, after each time point, to a treatment corresponding to one of the following treatment options performed as a function of the generated sensor values, wherein the treatment options include:
increasing the data range when n of the generated sensor values are outside the data range during a first time window,
decreasing the data range when m of the generated sensor values are within the data range during a second time window, and
otherwise leaving the data range unchanged.
